(19) United States
(12) Patent Application Publication
(10) Pub. No.: US 2024/0319140 A1
(43) Pub. Date: Sep. 26, 2024

(54) TRANSMISSION ANGLE CALIBRATION

(71) Applicant: Baker Hughes Holdings LLC, Houston, TX (US)

(72) Inventors: Siva SANKAR Y, Bangalore (IN); Appu GOPAKUMAR, Breda (NL); Jiamin LEI, Shanghai (CN)

(21) Appl. No.: 18/570,940

(22) PCT Filed: Jun. 17, 2022
(86) PCT No.: PCT/US2022/073024

§ 371 Date: Dec. 15, 2023

(30) Foreign Application Priority Data
Jun. 24, 2021 (IN) 202111028478

(51) Int. Cl. G01N 29/04; G01N 29/06; G01N 29/11; G01N 29/30; G01N 29/44

(52) U.S. Cl. CPC G01N 29/043; G01N 29/0645; G01N 29/11; G01N 29/4454; G01N 29/30; G01N 2291/044

(57) ABSTRACT

A calibration method includes receiving data characterizing a plurality of acoustic signals reflected by a defect in a target object, and a first depth of the defect relative to a surface of the target object. A first acoustic signal and a second acoustic signal are detected by a detector at a first location and a second location, respectively, on the surface of the target object. The plurality of acoustic signal includes the first acoustic signal and the second acoustic signal. The method also includes determining an envelope function based on at least the first acoustic signal and the second acoustic signal. The method further includes identifying a target distance between the detector and the defect. The target distance is associated with a peak value of the envelop function. The method also includes calculating a detection angle based on the target distance and the first depth of the defect.

### BACKGROUND

Non-destructive testing (NDT) is a class of analytical techniques that can be used to inspect a target, without causing damage, to ensure that the inspected target meets required specifications. For this reason, NDT has found wide acceptance in industries such as aerospace, power generation, oil and gas transport or refining, and transportation, that employ structures that are not easily removed from their surroundings.

In ultrasonic testing, acoustic (sound) energy in the form of waves can be directed towards a target object (e.g., train wheel). As the ultrasonic waves contact and penetrate the train wheel, they can reflect from features such as outer surfaces and interior defects (e.g., cracks, porosity, etc.). An ultrasonic sensor can acquire ultrasonic measurements of acoustic strength as a function of time. Subsequently, these ultrasonic measurements can be analyzed to provide testing results that characterize defects present within a train wheel, such as their presence or absence, location, and/or size.

### SUMMARY

Various aspects of the disclosed subject matter may provide one or more of the following capabilities.

A method includes receiving data characterizing a plurality of acoustic signals reflected by a defect in a target object, and a first depth of the defect relative to a surface of the target object. A first acoustic signal and a second acoustic signal are detected by a detector at a first location and a second location, respectively, on the surface of the target object. The plurality of acoustic signal includes the first acoustic signal and the second acoustic signal. The method also includes determining an envelope function based on at least the first acoustic signal and the second acoustic signal. The method further includes identifying a target distance between the detector and the defect. The target distance is associated with a peak value of the envelop function. The method also includes calculating a detection angle based on the target distance and the first depth of the defect.

One or more of the following features can be included in any feasible combination.

In some implementations, the method includes rendering, in a graph in a graphical user interface display space, a first visual representation of the first acoustic signal and a second visual representation of the second acoustic signal. The graph includes a first axis indicative of distance between the defect and the detector, and a second axis indicative of amplitudes of acoustic signals detected by the detector. The method also includes rendering, in the graph, a third visual representation of the envelop function. In some implementations, the method includes rendering, in the graph, a fourth visual representation of a measurement gate. The fourth visual representation is rendered between a first distance value and a second distance value on the first axis and between a first acoustic amplitude value and a second acoustic amplitude value on the second axis

In some implementations, the method further includes receiving a first user input indicative of the first distance value and a second user input indicative of the second distance value. In some implementations, the method further includes receiving a third user input indicative of the first acoustic amplitude value and a fourth user input indicative of the second acoustic amplitude value. In some implementations, the method further includes receiving a third user input indicative of the first acoustic amplitude value and a fourth user input indicative of the second acoustic amplitude value. In some implementations, the method further includes determining the first distance value and the second distance value by a predetermined function, wherein the predetermined function is configured to receive the target distance as input and provide the first distance value and the second distance value as output

In some implementations, the envelop function is determined by fitting peak values of the at least the first acoustic signal and the second acoustic signal. In some implementations, the method further includes identifying a location range associated with the first axis, wherein the location range includes locations of the detector at which measurement of each of the plurality of acoustic signal is performed.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, etc.

These and other capabilities of the disclosed subject matter will be more fully understood after a review of the following figures, detailed description, and claims.

### BRIEF DESCRIPTION OF THE FIGURES

These and other features will be more readily understood from the following detailed description taken in conjunction with the accompanying drawings. The patent or application file contains at least one drawing executed in color. Copies of this patent or patent application publication with color drawings will be provided by the Office upon request and payment of the necessary fee.

FIG. 1 is a flow chart of an exemplary method for transmission angle calibration;

FIG. 2 is a schematic illustration of an acoustic detection system that can detect defects in the target object; and

FIG. 3 illustrates an exemplary GUI display space that includes a graph with plots of a first acoustic signals detected by the acoustic detection system of FIG. 2.

### DETAILED DESCRIPTION

Objects in industrial processes can develop defects, such as cracks and damages, over time during use. The defects can increase in size over a period of time, which can be undesirable (e.g., leading to down time, injury, etc.). This can be avoided by periodic inspection. In some cases, the defects can be located beneath the surface of the object (or target object) and may not be visible. Such defects can be detected using ultrasonic testing. In ultrasonic testing, ultrasonic probes can be positioned on the surface of the target object which can transmit acoustic signal (or ultrasonic waves) in the target object and detect a portion of the transmitted acoustic signal reflected by the defect (also referred to as “echo”). Echo can be indicative of various properties of the defect (e.g., location of the defect, size of the defect, etc.). A visual representation of the information associated with the echo can be rendered in a graphical user interface (GUI) display space. This visual representation is referred to as defect detection curve or “A-scan” curve. For example, the amplitude of the echo (indicative of size of the defect) can be plotted as a function of the depth of the defect associated with the echo. The aforementioned plot in the GUI display space can be updated when a new echo is detected (e.g., a new echo associated with the same or a different defect detected in real-time).

In some implementations, the acoustic cross-section of the defect can vary depending on the direction from which the acoustic signal impinges on the defect. Therefore, it can be desirable to position the ultrasonic probes on the surface of the target object and transmit the acoustic signal (e.g., at a predetermined transmission angle relative to the ultrasonic probe/surface of the target object) to increase the cross-sectional area (e.g., maximize the cross-sectional area) of the defect that interacts with the acoustic signal. If the transmission angle of the acoustic signal remains unchanged, the location of the ultrasonic probe (on the surface of the target object) suitable for detecting a defect (e.g., by having a large cross-sectional area) can be determined. However, the transmission angle of the ultrasonic probe can change over time (e.g., due to wear and tear of the ultrasonic probe). As a result it can be desirable to recalibrate the ultrasonic measurement process to determine the transmission angle.

Recalibration of transmission angle can include performing acoustic measurements at multiple locations on the surface of a test object with a defect at a known depth. For example, the ultrasonic probe can be moved to a location on the surface of the test object, an acoustic measurement can be performed and an A-scan curve can be generated (in a GUI) based on the acoustic measurement. This process can be repeated for multiple locations that can result in multiple A-scan curves in the GUI. Existing transmission angle recalibration techniques include manually varying the range of the plot of the A-scan curve (e.g., the horizontal x-axis) to ensure that the multiple A-scan curves simultaneously appear on the GUI, and identifying the A-scan curve with the highest amplitude (e.g., which can correspond to the measurement of a large cross-section of the defect). The location corresponding to the measurement of the identified A-scan curve and the known depth of the defect can be used to determine the transmission angle of the acoustic signal. However, manually adjusting the range of the A-scan plot and identifying the A-scan curve can be slow, labor-intensive and prone to error. For example, an inspector may need to manually sift through the A-scan curves, vary the range of the A-scan plot and identify the A-scan curve with the highest peak. Moreover, the identified peak of the A-scan curve may not correspond to the desirable position of acoustic signal measurement on the surface of the target object. For example, an acoustic measurement may not be performed at the location that corresponds to an A-scan curve with the highest amplitude.

In some implementations of the current subject matter, a range of the A-scan plot that includes multiple A-scan curves identified and an envelop curve corresponding to the A-scan curves can be generated (e.g., by a recalibration system) and displayed in a graph of a GUI. The peak of the envelope curve can be determined and a corresponding location on the test object surface can be identified. Based on the identified location and the depth of the defect in the test object, the detection angle can be determined.

In some implementations, a gate can be used to identify the peak values of the A-scan plots. For example, a translucent graphical object representative of the gate (or gate graphical object) can be superimposed on the graph. A user can move the graphical object and/or vary the size of the graphical object such that various A-scan peaks are superimposed by the graphical object and information associated with the superimposed A-scan peaks are displayed (e.g., in a data box displayed over the graph). The displayed information can include, for example, x-axis values (e.g., indicative of the distance between the defect and the detector when the various A-scan curves were measured) and the y-axis values (e.g., indicative of the peak amplitude of the acoustic signals measured by the detector) of the peak of the various A-scan curves.

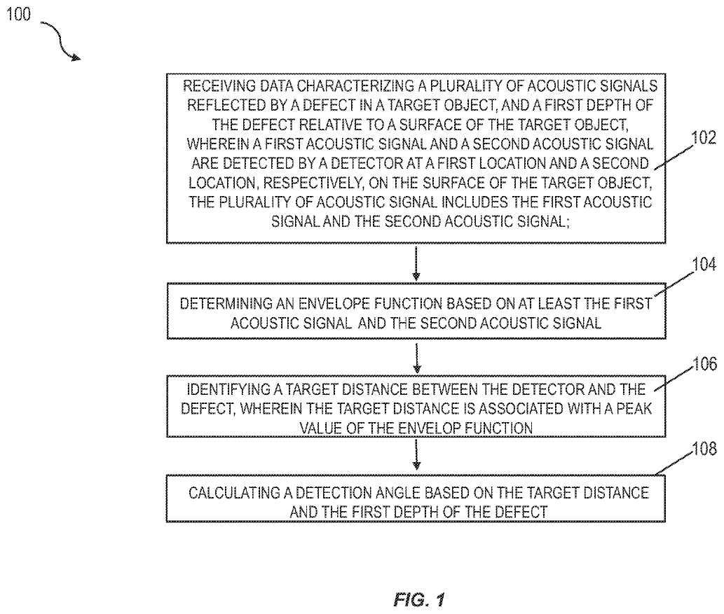

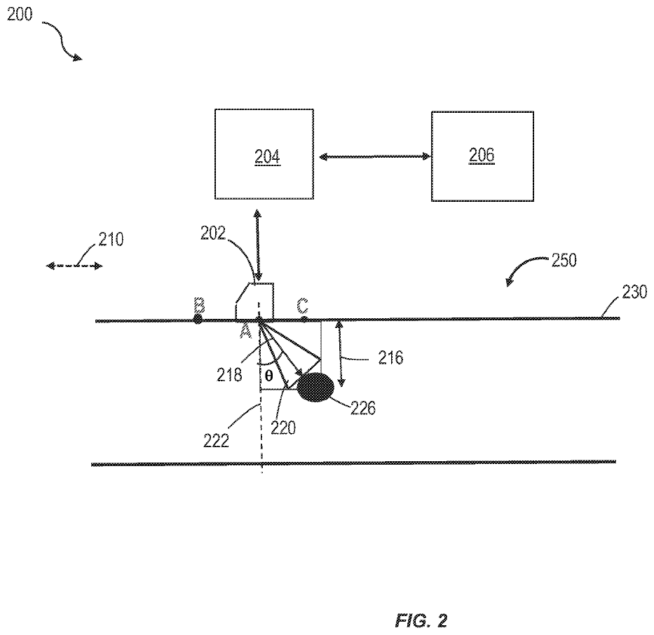

FIG. 1 is a flow chart of an exemplary method for calibration of transmission angle of acoustic signal. At 102, data characterizing a plurality of acoustic signals reflected by a defect in a target object, and a first depth of the defect relative to a surface of the target object is received. The acoustic signals can be detected by the detector at various locations on the surface of the target object. For example, the detector can detect a first acoustic signal at a first location on the surface of the target object and can detect a second acoustic signal at a second location on the surface of the target object. The plurality of acoustic signal received at step 102 can include the first acoustic signal and the second acoustic signal. FIG. 2 is a schematic illustration of an acoustic detection system 200 that can detect defects in the target object 250. The detection system 200 can include a detector 202 configured to transmit an acoustic signal into the target object 250 and detect a reflection of the transmitted acoustic signal from the defect 226 in the target object 250.

The detector 202 can be configured to move along the surface 230 of the target object 250. For example, the detector 202 can move along the direction 210 to locations A, B and C on the surface 230. At each of these locations, the detector 202 can perform one or more defect detections in the target object 250 by emission of an acoustic signal 220 and detection of a reflection of the acoustic signal (or a portion thereof) by the defect 226. For example, the detector 202 can be positioned at location “A” and configured to transmit an acoustic signal 220 into the target object 250. The defect 226 located at a depth 216 (relative to the surface 230) and at a defect-detector distance 218 from the location A can reflect a portion of the acoustic signal which can be detected by the detector 202. The direction of transmission of the acoustic signal along the defect-detector distance 218 can be at a detection angle θ with respect to an axis 222 perpendicular to the surface 230 (or to a predetermined surface of the detector 202 [e.g., a surface adjacent to the surface 230]). The detection process can be performed at various locations on the surface 230 (e.g., at locations B and C by moving the detector 202 along the direction 210). The detection angle can change at the various measurement locations (e.g., as the defect-detector distance 218 changes while the depth 216 remains fixed).

The detector can determine the distance between the detector 202 and the defect 226 based on the time between the transmission of acoustic signal and detection of the echo. For example, the time between the transmission of acoustic signal and detection of the corresponding echo (“travel time”) can be indicative of defect distance (e.g., defect-detector distance 218). Distance between the detector 202 and the defect 226 can be determined by multiplying the speed of acoustic signal in the target object with the travel time.

The amplitude of the echo can be related to the size and/or cross-section of the defect and the defect-detector distance. The echo amplitude can be directly proportional to the size and/or cross-section of the defect and inversely proportional to the defect distance. In other words, for a given defect distance, the echo amplitude increases as the size/cross-section of the defect increases. On the other hand, for a given size of the defect, the echo amplitude decreases as the defect-detector distance increases. In some implementations, the acoustic signal can include two peaks (e.g., corresponding to the reflection of the acoustic signal from the proximal and distal surfaces of the defect 226).

The detection system 200 can also include a computing device 204 communicatively coupled to the detector 202. The computing device 204 can receive data characterizing defect depth and data characterizing the acoustic signal (e.g., echo amplitude, travel time, etc.) detected by the detector 202. In some implementations, the computing device 204 can receive data characterizing multiple echo detections. For example, the detector 202 can be moved to a new location “B” and configured to transmit an acoustic signal into the target object 250. The defect 226 located at a depth 216 (relative to the surface 230) can reflect a corresponding second echo which can be detected by the detector 202. The computing device 204 can receive data characterizing the second echo (e.g., echo amplitude, travel time, defect depth etc.) associated with the defect 226 and detected by the detector 202.

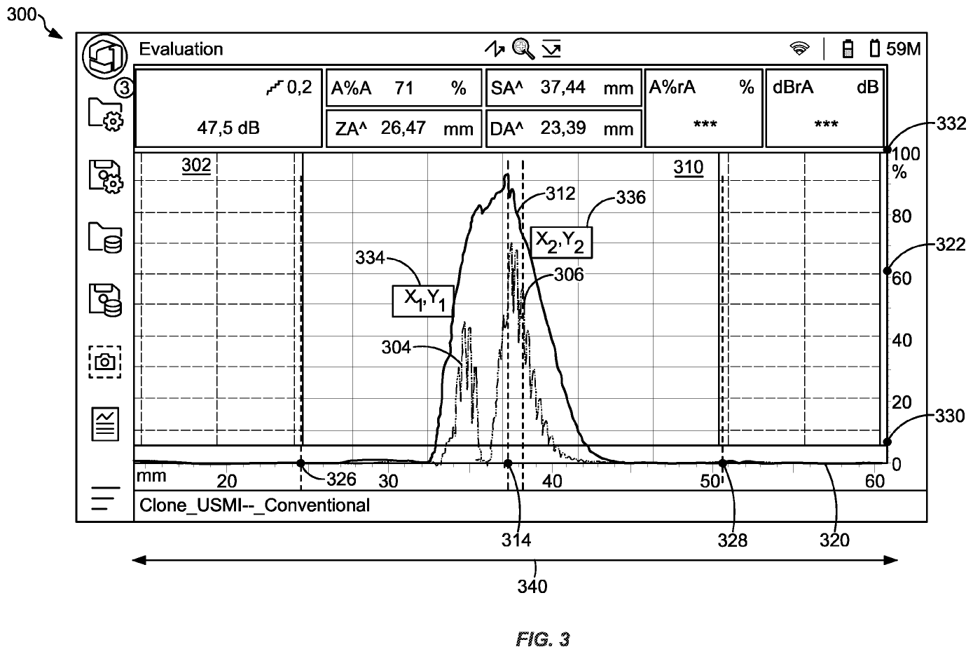

In some implementations, data characterizing the detected acoustic signal(s) can be rendered (e.g., plotted) in a graph in a graphical user interface (GUI) display space (e.g., associated with the computing device 204. For example, a first visual representation of the first acoustic signal (e.g., detected at location A) and a second visual representation of the second acoustic signal (e.g., detected at location B) can be rendered in the graph. The graph can include a first axis indicative of distance between the defect and the detector, and a second axis indicative of amplitudes of acoustic signals detected by the detector. FIG. 3 illustrates an exemplary GUI display space 300 that includes a graph 302 with plots of a first acoustic signal 304 and a second acoustic signal 306 detected at different location on the surface of the target object (e.g., surface 230 of target object 250). The graph 302 includes a first axis 320 indicative of distance between the detector and the defect and a second axis 322 indicative of the amplitude of the acoustic signal detected by the detector.

Returning back to FIG. 1, at step 104, an envelope function is determined from the various acoustic signals detected by the detector at various locations on the surface of the target object. For example, the envelop function can be based on (e.g., calculated from) at least two acoustic signals (e.g., first acoustic signal 304, the second acoustic signal 306, etc.). In some implementations, the envelop curve is determined by fitting peak values (e.g., parabolic fitting) of at least two acoustic signals. A visual representation of the envelop curve can be rendered (e.g., plotted) in the graph (e.g., envelop curve 312 is rendered in the graph 302).

At step 106, a target distance between the detector and the defect can be identified. The target distance is associated with a peak value (e.g., maximum value) of the envelop function. For example, the computing device 204 can identify the peak value 314 indicative of the distance between the detector 202 and the defect 226 (e.g., the target distance) at which the amplitude of the detected acoustic signal has the highest value or is estimated to have the highest value. In some implementation, it can be desirable to calculate the defect-detector distance based on the peak value of the envelop function instead of the peak value of the acoustic signal with the highest amplitude because the former may be a better indicator of the location of the detector when the acoustic signal amplitude has a peak value (e.g., maximum value). For example, as illustrated in FIG. 3, the peak value of the envelop curve 312 is higher than the peak values of first acoustic signal 304 or the second acoustic signal 306. In other words, the location of the detector where the acoustic signal amplitude is likely to be the highest may be between the locations where the first acoustic signal 304 is measured and the second acoustic signal 306 is measured. At step 108, a detection angle (e.g., detection angle θ) is calculated based on the target distance and the depth of the defect. For example, the tangent of the detection angle θ is the ratio of the defect depth 216 and the target distance (e.g., defect-detector distance 218 between the detector 202 and the defect 226).

In some implementations, a gate graphical object 310 can be rendered (e.g., by the computing device 204) in the graph 302. The size and location of the gate graphical object 310 can be based on the defect-detector distance, defect depth, input from a user (e.g., from a user computing device 206), or a combination thereof. As illustrated in FIG. 3, the graphical object 310 extends from a first distance value 326 to a second distance value 328 on the first axis 320, and between a first acoustic amplitude value 330 and a second acoustic amplitude value 332 on the second axis 322. In some implementations, the first distance value 326 and the second distance value 328 can be determined by a predetermined function. The predetermined function can be configured to receive the target distance (e.g., distance corresponding to the peak of the envelop function 312) as input and provide the first distance value 326 and the second distance value 328 as output. Additionally or alternately, in some implementations, the first distance value 326 and the second distance value 328 can be determined based on a first and a second user input, respectively. For example, a user can click and drag the left boundary and the right boundary of the gate graphical object 310. In some implementations, a first acoustic amplitude value 330 and a second acoustic amplitude value 332 can be determined based on a third and a fourth user input, respectively. For example, a user can click and drag the bottom boundary and the top boundary of the gate graphical object 310.

In some implementations, peak values associated with one or more acoustic signals (e.g., acoustic signal of the plurality of acoustic signals whose data is received at step 102) whose peaks overlap with the gate graphical object 310 can be displayed. For example, the gate graphical object 310 can be moved in the graph 302 (e.g., by dragging and dropping by a user) such that one or more peaks of the various acoustic signals (e.g., first acoustic signal 304, second acoustic signal 306, etc.) are located between the first location value 326 and the second location value 328 (along the first axis 320) and between the first acoustic amplitude value 330 and the second acoustic amplitude value 332. In some implementations, if the gate graphical object 310 overlaps with the peak of an acoustic signal, a dialog box can be displayed on graph 302 that include the x- and y-coordinates values (e.g., corresponding to the defect-detector distance value and the acoustic signal amplitude value, respectively). For example, as illustrated in FIG. 3, the gate graphical object 310 overlaps with the peaks of the first acoustic signal 304, and the second acoustic signal 306, a first dialog box 334 and a second dialog box 336 are displayed.

In some implementations, a range 340 of the first axis 320 to be displayed in the graph 302 can be determined (e.g., by the computing system 204). It can be desirable of display only a portion of the first axis 320 as it can allow for better viewing of the plots of the acoustic signals, envelop function, dialog boxes, etc. In some implementations, the determination of the range 340 can be based on predetermined estimations of defect-detector distance. For example, the range of defect depths (e.g., defect depth 216) may be known (e.g., ranging from 1 millimeter to 50 millimeters). Additionally, range of location values of the detector (e.g., detector 202) on the surface of the target object (e.g., surface 230 of target object 250) during the detection process may be known. Based on these ranges, the range of defect-detector distance can be calculated (e.g., by using the Pythagorean theorem).

Other embodiments are within the scope and spirit of the disclosed subject matter. For example, the monitoring system described in this application can be used in facilities that have complex machines with multiple operational parameters that need to be altered to change the performance of the machines (e.g., power generating turbines). Usage of the word “optimize”/“optimizing” in this application can imply “improve”/“improving.”

Certain exemplary embodiments are described herein to provide an overall understanding of the principles of the structure, function, manufacture, and use of the systems, devices, and methods disclosed herein. One or more examples of these embodiments are illustrated in the accompanying drawings. Those skilled in the art will understand that the systems, devices, and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention. Further, in the present disclosure, like-named components of the embodiments generally have similar features, and thus within a particular embodiment each feature of each like-named component is not necessarily fully elaborated upon.

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processor of any kind of digital computer. Generally, a processor will receive instructions and data from a Read-Only Memory or a Random Access Memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, (e.g., EPROM, EEPROM, and flash memory devices); magnetic disks, (e.g., internal hard disks or removable disks); magneto-optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The techniques described herein can be implemented using one or more modules. As used herein, the term “module” refers to computing software, firmware, hardware, and/or various combinations thereof. At a minimum, however, modules are not to be interpreted as software that is not implemented on hardware, firmware, or recorded on a non-transitory processor readable recordable storage medium (i.e., modules are not software per se). Indeed “module” is to be interpreted to always include at least some physical, non-transitory hardware such as a part of a processor or computer. Two different modules can share the same physical hardware (e.g., two different modules can use the same processor and network interface). The modules described herein can be combined, integrated, separated, and/or duplicated to support various applications. Also, a function described herein as being performed at a particular module can be performed at one or more other modules and/or by one or more other devices instead of or in addition to the function performed at the particular module. Further, the modules can be implemented across multiple devices and/or other components local or remote to one another. Additionally, the modules can be moved from one device and added to another device, and/or can be included in both devices.

The subject matter described herein can be implemented in a computing system that includes a back-end component (e.g., a data server), a middleware component (e.g., an application server), or a front-end component (e.g., a client computer having a graphical user interface or a web interface through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

Approximating language, as used herein throughout the specification and claims, may be applied to modify any quantitative representation that could permissibly vary without resulting in a change in the basic function to which it is related. Accordingly, a value modified by a term or terms, such as “about” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

What is claimed is:

1. A method comprising:
receiving data characterizing a plurality of acoustic signals reflected by a defect in a target object, and a first depth of the defect relative to a surface of the target object,
wherein a first acoustic signal and a second acoustic signal are detected by a detector at a first location and a second location, respectively, on the surface of the target object, the plurality of acoustic signal includes the first acoustic signal and the second acoustic signal;
determining an envelope function based on at least the first acoustic signal and the second acoustic signal;
identifying a target distance between the detector and the defect, wherein the target distance is associated with a peak value of the envelop function; and
calculating a detection angle based on the target distance and the first depth of the defect.

2. The method of claim 1, further comprising:
rendering, in a graph in a graphical user interface display space, a first visual representation of the first acoustic signal and a second visual representation of the second acoustic signal, the graph including a first axis indicative of distance between the defect and the detector, and a second axis indicative of amplitudes of acoustic signals detected by the detector; and
rendering, in the graph, a third visual representation of the envelop function.

3. The method of claim 2, further comprising rendering, in the graph, a fourth visual representation of a measurement gate, wherein the fourth visual representation is rendered between a first distance value and a second distance value on the first axis and between a first acoustic amplitude value and a second acoustic amplitude value on the second axis.

4. The method of claim 3, further comprising receiving a first user input indicative of the first distance value and a second user input indicative of the second distance value.

5. The method of claim 3, further comprising receiving a third user input indicative of the first acoustic amplitude value and a fourth user input indicative of the second acoustic amplitude value.

6. The method of claim 3, further comprising determining the first distance value and the second distance value by a predetermined function, wherein the predetermined function is configured to receive the target distance as input and provide the first distance value and the second distance value as output.

7. The method of claim 3, further comprising displaying peak values associated with one or more acoustic signals of the plurality of acoustic signals that have peak values detected between the first location value and the second location value, and wherein the peak values are greater than the third acoustic amplitude value and the fourth acoustic amplitude value.

8. The method of claim 1, wherein the envelop function is determined by fitting peak values of the at least the first acoustic signal and the second acoustic signal.

9. The method of claim 1, further comprising identifying a location range associated with the first axis, wherein the location range includes locations of the detector at which measurement of each of the plurality of acoustic signal is performed.

10. A system comprising:
at least one data processor;
memory coupled to the at least one data processor, the memory storing instructions to cause the at least one data processor to perform operations comprising:
receiving data characterizing a plurality of acoustic signals reflected by a defect in a target object, and a first depth of the defect relative to a surface of the target object, wherein a first acoustic signal and a second acoustic signal are detected by a detector at a first location and a second location, respectively, on the surface of the target object, the plurality of acoustic signal includes the first acoustic signal and the second acoustic signal;
determining an envelope function based on at least the first acoustic signal and the second acoustic signal;
identifying a target distance between the detector and the defect, wherein the target distance is associated with a peak value of the envelop function; and
calculating a detection angle based on the target distance and the first depth of the defect.

11. A computer program product comprising a machine-readable medium storing instructions that, when executed by at least one programmable processor, cause the at least one programmable processor to perform operations comprising:
receiving data characterizing a plurality of acoustic signals reflected by a defect in a target object, and a first depth of the defect relative to a surface of the target object,
wherein a first acoustic signal and a second acoustic signal are detected by a detector at a first location and a second location, respectively, on the surface of the target object, the plurality of acoustic signal includes the first acoustic signal and the second acoustic signal;
determining an envelope function based on at least the first acoustic signal and the second acoustic signal;
identifying a target distance between the detector and the defect, wherein the target distance is associated with a peak value of the envelop function; and
calculating a detection angle based on the target distance and the first depth of the defect.
